(19) United States
(12) Patent Application Publication
(10) Pub. No.: US 2019/0033151 A1
(43) Pub. Date: Jan. 31, 2019

(54) RESILIENT COUPLING DEVICE

(71) Applicant: Sumitomo Riko Company Limited, Aichi (JP)

(72) Inventors: Susumu SATO, Aichi (JP); Tomohiro FUJIKAWA, Aichi (JP)

(73) Assignee: Sumitomo Riko Company Limited, Aichi (JP)

(21) Appl. No.: 16/151,361

(22) Filed: Oct. 4, 2018

Related U.S. Application Data
(63) Continuation of application No. PCT/JP2017/020713, filed on Jun. 2, 2017.

(30) Foreign Application Priority Data
Jul. 26, 2016 (JP) 2016-146111

(51) Int. Cl. G01L 5/16; G01L 1/14; G01L 1/20; F16F 15/08; F16F 1/38

(52) U.S. Cl. CPC G01L 5/165; G01L 1/142; F16F 1/38; F16F 15/08; G01L 1/20

(57) ABSTRACT

The disclosure provides a resilient coupling device, having an inner shaft member inserted into an outer tube member. The inner shaft member and the outer tube member are resiliently coupled in the radial direction by a main rubber resilient body. The inner shaft member has a tubular portion and is inserted into an inner hole of the tubular portion, the outer tube member has an insertion shaft member extending in the axial direction, and an outer peripheral surface of the insertion shaft member and an inner peripheral surface of the tubular portion are separated from and face one another in the radial direction. A first and second electrodes are respectively provided on the inner peripheral surface of the tubular portion and the outer peripheral surface of the insertion shaft member, to constitute a first sensor detecting an electrical change due to a relative displacement between the first and second electrodes.

### CROSS-REFERENCE TO RELATED APPLICATION

The present application is a continuation of PCT/JP2017/020713, filed on Jun. 2, 2017, and is related to and claims priority from Japanese patent application no. 2016-146111, filed on Jul. 26, 2016. The entire contents of the aforementioned application are hereby incorporated by reference herein.

### BACKGROUND OF THE DISCLOSURE

### Technical Field

The present disclosure relates to a resilient coupling device arranged, for example, between an end effector portion and an arm portion of a robot arm or on a supporting portion of a bridge, and so on. In particular, the present disclosure relates to a resilient coupling device having a structure that an inner shaft member is inserted into and resiliently coupled to an outer tube member by a main rubber resilient body.

### Related Art

Conventionally, in a robot arm and so on, for the purpose of improving safety and in order to reduce the force acting on a person from an end effector portion when the person touches the end effector portion, a resilient coupling device that is arranged between the end effector portion and an arm portion, i.e., coupling object members to provide an anti-vibration property has been studied. The resilient coupling device, for example, as disclosed in Japanese patent No. 5578728 (patent literature 1), has a structure that an inner shaft member is inserted into an outer tube member, and the inner shaft member and the outer tube member are resiliently coupled in a radial direction by means of a main rubber resilient body.

Additionally, it is proposed that, for example, in a robot arm that needs to ascertain the external force acting on the end effector portion, the external force acting between the end effector portion and the arm portion, or an amount of relative displacement of the end effector portion and the arm portion may be measured by arranging a sensor between the end effector portion and the arm portion. Japanese Laid-Open No. 2015-001384 (patent literature 2) discloses a structure capable of detecting the external force acting between the end effector portion and the arm portion by a piezoelectric layer formed by crystal and so on. Particularly, in the robot arm that requires a high-precision operation, the end effector portion and the arm portion are relatively and precisely positioned, and the sensor that detects the external force based on the relative displacement of the end effector portion and the arm portion has a high detection precision.

However, when the sensor with such a high detection precision is used, not only the external force exerted to the end effector portion, i.e., the detecting object, but also vibration that is inputted to the robot arm from the surroundings is detected by the sensor, so it is difficult to correctly detect the external force acting on the end effector portion.

In view of the above situation, a resilient coupling device is provided to have a structure capable of providing a cushion and resilient coupling for the coupling object member and detecting a force acting between the coupling object members.

### SUMMARY

According to the present disclosure, a resilient coupling device is provided to have a structure that an inner shaft member is inserted into an outer tube member and the inner shaft member and the outer tube member are resiliently coupled in a radial direction by a main rubber resilient body, the inner shaft member is provided with a tubular portion, the outer tube member is provided with an insertion shaft member extending in an axial direction, the insertion shaft member is inserted into an inner hole of the tubular portion in the inner shaft member, an outer peripheral surface of the insertion shaft member and an inner peripheral surface of the tubular portion in the inner shaft member are separated from and face one another in the radial direction, the inner peripheral surface of the tubular portion in the inner shaft member is provided with a first electrode, the outer peripheral surface of the insertion shaft member of the outer tube member is provided with a second electrode. A first sensor, which detects an electrical change that accompanies a relative displacement of the first electrode and the second electrode, comprises the first electrode and the second electrode.

### BRIEF DESCRIPTION OF THE DRAWINGS

FIG. 1 is a perspective view of a resilient coupling device according to the first embodiment of the present disclosure.

FIG. 2 is a perspective partial cross-sectional view of the resilient coupling device shown in FIG. 1.

FIG. 3 is a cross-sectional view of the resilient coupling device shown in the FIG. 1.

FIG. 4 illustrates a configuration of electrodes on the resilient coupling device shown in FIG. 1.

FIG. 5 is a cross-sectional view of the resilient coupling device shown in FIG. 1, and illustrates a state that a load in an axial direction is input between an inner shaft member and an outer tube member.

FIG. 6 illustrates a relative displacement of the first electrodes and the second electrodes due to the input in an axial direction in the resilient coupling device shown in FIG. 1.

FIG. 7 illustrates a relative displacement of the first electrodes and the second electrodes due to the input in a circumferential direction in the resilient coupling device shown in FIG. 1.

FIG. 8 is a cross-sectional view of a resilient coupling device according to the second embodiment of the present disclosure.

### DESCRIPTION OF THE EMBODIMENTS

Embodiments of the present disclosure are described below with reference to the drawings.

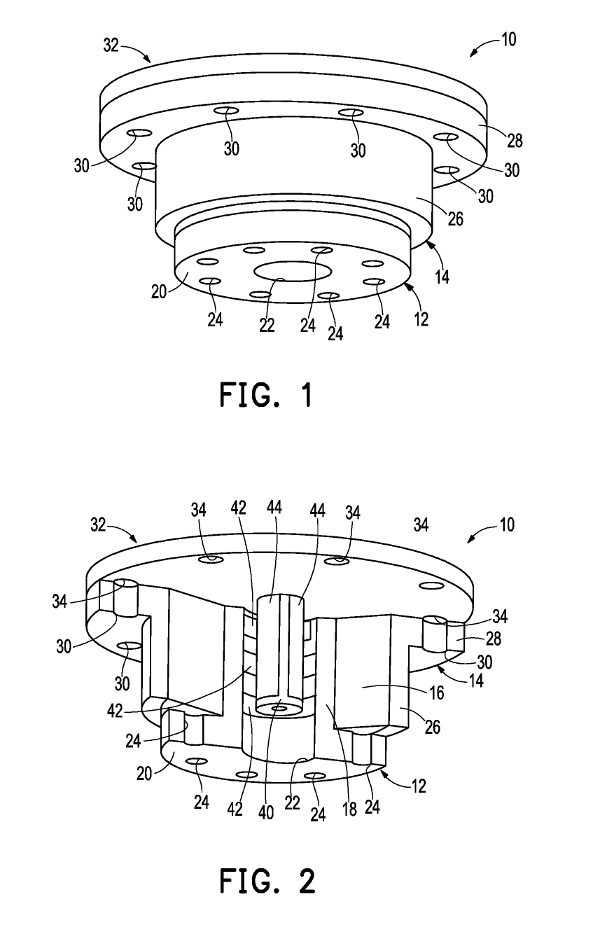

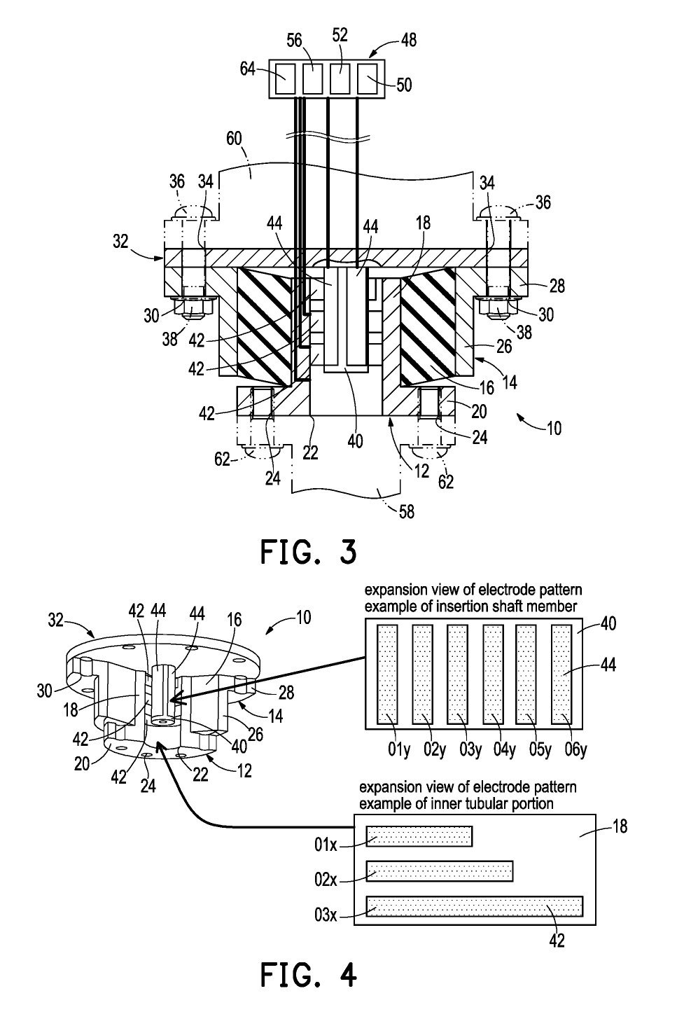

In FIGS. 1-3, a resilient coupling device 10 according to the first embodiment of the present disclosure is shown. The resilient coupling device 10 has a structure that an inner shaft member 12 is inserted into an outer tube member 14, and the inner shaft member 12 and the outer tube member 14 are resiliently coupled in a radial direction by a main rubber resilient body 16. In addition, in the following description, in principle, a vertical direction refers to a vertical direction in FIG. 3.

More specifically, the inner shaft member 12 is a hard member that is formed by metals or synthetic resins, and integrally includes an inner tubular portion 18 and an inner flange 20. The inner tubular portion 18 serves as a tubular portion that is formed by an electrical insulation material and presents a cylindrical shape with a small diameter, and the inner flange 20 extends to an outer periphery in a lower end portion in the axial direction of the tubular portion 18. In addition, in the center of the radial direction of the inner shaft member 12, an inner hole 22 that vertically extends in the axial direction is arranged, and the inner hole 22 vertically passes through the inner shaft member 12. Furthermore, inner mounting holes 24 that vertically pass through a plurality of locations in the circumferential direction is formed on the inner flange 20. In addition, the inner shaft member 12 is not limited to a member completely formed by an electrical insulation material; for example, it can be that the inner shaft member 12 is formed by a conductive metal, etc., and an electrical insulation surface layer is formed on the inner peripheral surface of the inner tubular portion 18. In short, if the forming material of the inner shaft member 12 allows for sensing by a first sensor 46 described below, it is not particularly limited to the electrical insulation material.

The outer tube member 14 is a hard member that is formed by metals or synthetic resins, and integrally includes an outer tubular portion 26 that has cylindrical shape with a large diameter, and an outer flange 28 that extends to the outer periphery in an upper end portion in the axial direction of the outer tubular portion 26. In addition, on the outer flange 28 of the outer tube member 14, outer mounting holes 30 that vertically pass through are formed at a plurality of locations in the circumferential direction.

Furthermore, the inner tubular portion 18 of the inner shaft member 12 is inserted into the outer tubular portion 26 of the outer tube member 14, and the main rubber resilient body 16 is arranged in the radial direction between the inner tubular portion 18 of the inner shaft member 12 and the outer tubular portion 26 of the outer tube member 14. The main rubber resilient body 16 has a substantially thick cylindrical shape, the inner peripheral surface is adhered by vulcanization to the outer peripheral surface of the inner tubular portion 18 of the inner shaft member 12, and the outer peripheral surface is adhered by vulcanization to the inner peripheral surface of the outer tubular portion 26 of the outer tube member 14. In addition, the main rubber resilient body 16 of the embodiment may be formed as an integral vulcanization molded product that includes the inner shaft member 12 and the outer tube member 14. In addition, the main rubber resilient body 16 of the embodiment may be formed by an electrical insulation rubber material.

In addition, the outer tube member 14 includes a mounting member 32 with a substantially disc shape. The mounting member 32 is a hard member that is formed by metals or synthetic resins, and bolt holes 34 corresponding to the outer mounting holes 30 are formed on the outer periphery. Furthermore, the mounting member 32 is overlapped with the outer flange 28 of the outer tube member 14, and as shown in FIG. 3, the mounting member 32 is fixed to the outer flange 28 by screwing nuts 38 onto outer mounting bolts 36 that are inserted into the outer mounting holes 30 of the outer flange 28 and the bolt holes 34 of the mounting member 32. In addition, the mounting member 32 and the outer flange 28 are fastened to an arm portion 60 (described below), which is a coupled member, by the outer mounting bolts 36 and the nuts 38. Of course, for integrally handling the outer tube member 14 and the mounting member 32 before being fastened to the arm portion 60, the outer flange 28 and the mounting member 32 may be temporarily fixed by adhering, welding, or bolt fixing, etc.

Furthermore, an insertion shaft member 40 that protrudes downward is integrally formed at the central portion in the radial direction of the mounting member 32. The insertion shaft member 40 is formed by an electrical insulation material, and presents a substantially cylinder shape or a substantially circular tube shape that has an outer diameter smaller than the radial inner size of the inner hole 22 of the inner shaft member 12, and an axial size is shorter than the inner tubular portion 18 of the inner shaft member 12. In addition, the insertion shaft member 40 of the embodiment is formed on the mounting member 32 separated from the outer tubular portion 26, but may be fixed to the outer tube member 14 by fixing the mounting member 32 to the outer flange 28. In addition, the insertion shaft member 40 of the embodiment has a shape having an outer peripheral surface with a substantially cylindrical shape; however, the insertion shaft member 40 may also have a shape having an outer peripheral surface with a substantially polygonal tube shape. In this case, the inner peripheral surface of the tubular portion 18 in the inner shaft member 12 may have a substantially polygonal tube shape correspondingly.

The insertion shaft member 40 is inserted into the inner hole 22 of the inner tubular portion 18 in the inner shaft member 12 in a state that the mounting member 32 is provided on the outer tube member 14, and the inner peripheral surface of the inner tubular portion 18 in the inner shaft member 12 and the outer peripheral surface of the insertion shaft member 40 are separated by a predefined distance from and face one another in the radial direction. In the embodiment, a tubular space is formed across the entire axial direction between the inner shaft member 12 and the insertion shaft member 40 in the radial direction, and the inner shaft member 12 and the insertion shaft member 40 are spaced apart without being coupled by the rubber resilient body, etc.

In addition, in the inner peripheral surface of the inner tubular portion 18 in the inner shaft member 12, a plurality of first electrodes 42 are fixed in a state that is electrically insulated from the inner tubular portion 18. The first electrode 42 is a thin sheet shape, and may be formed by metals such as copper or aluminium alloys, or conductive materials such as a conductive rubber or a conductive resin. In the embodiment, the first electrode 42 is a longitudinal strip-shaped thin film in the circumferential direction, and a plurality of the first electrodes 42 are vertically arranged in parallel in the axial direction with a predetermined distance between each other. In the embodiment, as shown in an expansion view of FIG. 4, three first electrodes 42 are arranged in the axial direction. In addition, in the expansion view of FIG. 4, three first electrodes 42, 42, 42 are sequentially marked from the top with numbers 01x, 02x, and 03x.

Furthermore, as shown in FIG. 4, the 01x-03x of the first electrodes 42 have mutually different lengths in the circumferential direction, the 01x of the first electrode 42 that is arranged on a topmost part is shorter than the 02x of the first electrode 42 that is arranged in the middle in the vertical direction, and the 03x of the first electrode 42 that is arranged on a lowest part is longer than the 02x of the first electrode 42 that is arranged in the middle in the vertical direction.

In addition, on the outer peripheral surface of the insertion shaft member 40 that is fixed to the outer tube member 14, a plurality of second electrodes 44 are fixed in a state electrically insulated from the insertion shaft member 40. Similar to the first electrodes 42, the second electrodes 44 are formed by conductive materials and are strip-shaped thin films extending in the circumferential direction, and the plurality of the second electrodes 44 are separated from each other by a predetermined distance in the axial direction and arranged in parallel. In the embodiment, as shown in the expansion view of FIG. 4, six second electrodes 44 are arranged in the axial direction, the six second electrodes 44, 44 . . . 44 have the same shape substantially, and are arranged in the circumferential direction with equal intervals. In addition, in the expansion view of FIG. 4, the six second electrodes 44, 44 . . . 44 are sequentially marked from the left with numbers 01y, 02y . . . 06y.

Furthermore, the first electrodes 42 that are fixed to the inner peripheral surface of the inner tubular portion 18 of the inner shaft member 12, and the second electrodes 44 that are fixed to the outer peripheral surface of the insertion shaft member 40 provided on the outer tube member 14 face one another in the radial direction. More specifically, the shortest 01x of the first electrode 42 faces and crosses the 01y-03y of the second electrodes 44, and the 02x of the first electrode 42 which is set to an intermediate length faces and crosses the 01y-04y of the second electrodes 44. Furthermore, the longest 03x of the first electrode 42 faces and crosses all the second electrodes 44 (01y-06y). Furthermore, in each cross-facing part (referring to parts that face and cross one another) of the 01x-03x of the first electrodes 42 and the 01y-06y of the second electrodes 44, a capacitor is formed by using a space between the opposing surfaces of the inner peripheral surface of the inner tubular portion 18 and the outer peripheral surface of the insertion shaft member 40 as a dielectric layer, and the first sensor 46 which detects the relative displacement of the inner shaft member 12 and the outer tube member 14 based on the change of the electrostatic capacitance value of the capacitor serving as a sensor element 45, is formed to include the first electrode 42 and the second electrode 44.

As is apparent from the description above, the first sensor 46 of the embodiment is an electrostatic capacitance sensor that detects the electrostatic capacitance in each cross-facing part (the sensor element 45) of the first electrodes 42 and the second electrodes 44. Furthermore, based on change of an electrostatic capacitance that occurs accompanying a change in an area of the cross-facing part of or a facing distance between the first electrode 42 and the second electrode 44, the relative displacement of the inner shaft member 12 and the outer tube member 14 can be detected. In addition, in the embodiment, the first electrode 42 and the second electrode 44 are arranged mutually separated by a space from one another without being coupled in the radial direction by the rubber resilient body and the like in the cross-facing part, and the dielectric layer which constitutes the electrostatic capacitance sensor element 45 is formed by air which is filled in a space in the radial direction.

In addition, the sensor elements 45 are respectively formed in the cross-facing parts of the plurality of first electrodes 42 extending in the circumferential direction and the plurality of second electrodes 44 extending in the axial direction, thus the plurality of sensor elements 45 are arranged in a matrix form side by side in the circumferential direction and the axial direction.

In addition, as shown in FIG. 3, a sensor controller 48 that continually detects the electrostatic capacitance of each sensor element 45 and stores the detecting results is connected to the first electrodes 42 and the second electrodes 44, and the sensor controller 48 includes a power circuit 50 that serves as a power device for supplying operation voltage and a detecting circuit 52 that serves as a measuring device for detecting the electrostatic capacitance. The power circuit 50 selectively supplies the power to the 01x-03x of the first electrodes 42 and the 01y-06y of the second electrodes 44, and under control of a central processing unit (CPU) that is not shown in the drawing, a periodic waveform voltage acting as a voltage for measurement is scanningly applied to each cross-facing parts (the sensor element 45) of thirteen locations that form the capacitors. In this way, the electrostatic capacitance in each sensor element 45 can be detected by the first sensor 46. In addition, the sensor controller 48 includes a storage device 56 such as a hard disk drive, etc., and data of the electrostatic capacitance values that are continually detected can be stored in the storage device 56.

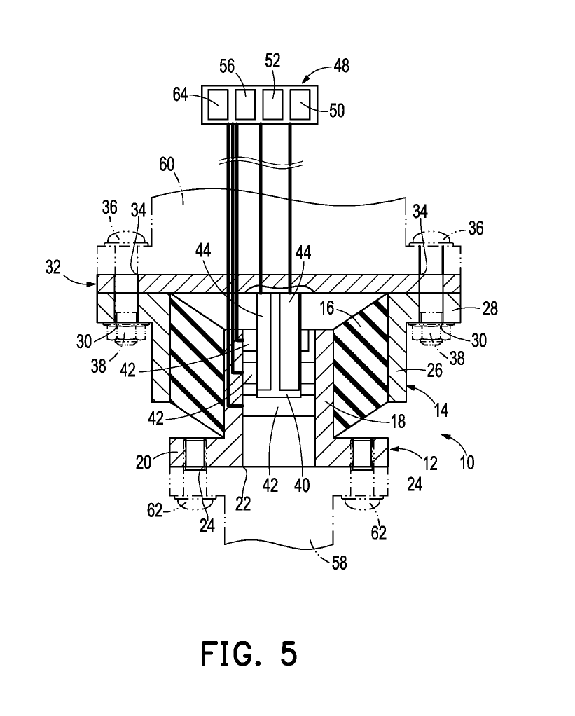

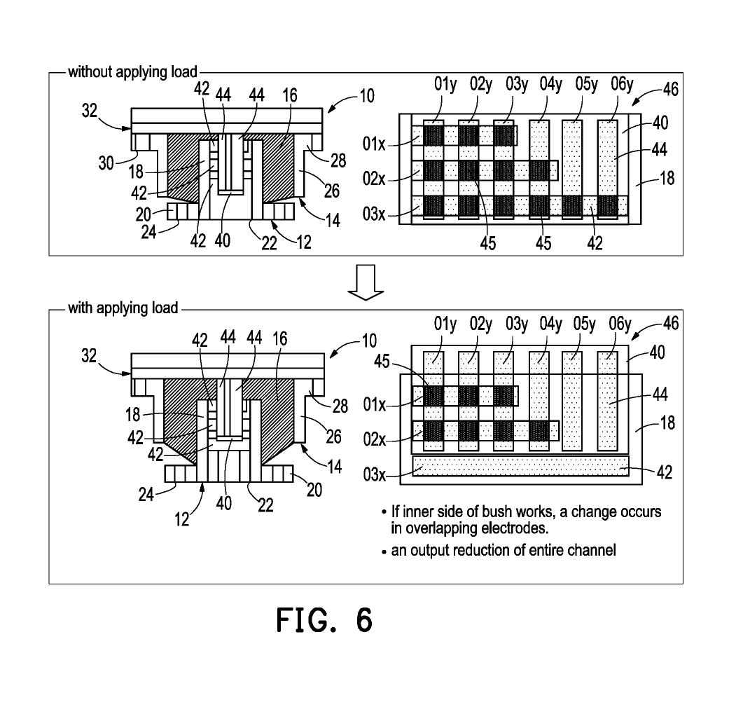

Specifically, for example, when an end effector portion 58 described below grips a workpiece, as shown in FIG. 5, the inner shaft member 12 and the outer tube member 14 relatively displace in the axial direction. On this occasion, with respect to an initial state shown as “without applying load” in FIG. 6, the first electrodes 42 and the second electrodes 44 relatively displace in the axial direction as in a state shown as “with applying load” in FIG. 6, and a change occurs in the cross-facing area of the radial direction of the first electrodes 42 and the second electrodes 44. That is, in an example of FIG. 6, the 03x of the first electrode 42 and the 01y-06y of the second electrodes 44 in the radial direction is not in cross-facing state, and the cross-facing area of the 03x of the first electrode 42 and the 01y-06y of the second electrodes 44 in the radial direction becomes 0. Therefore, in the first sensor 46, when the voltage for measurement is applied to the 03x of the first electrode 42 and the 01y-06y of the second electrodes 44, the detected electrostatic capacitance substantially becomes 0, and the downward relative displacement of the inner shaft member 12 in the axial direction with respect to the outer tube member 14 may be detected.

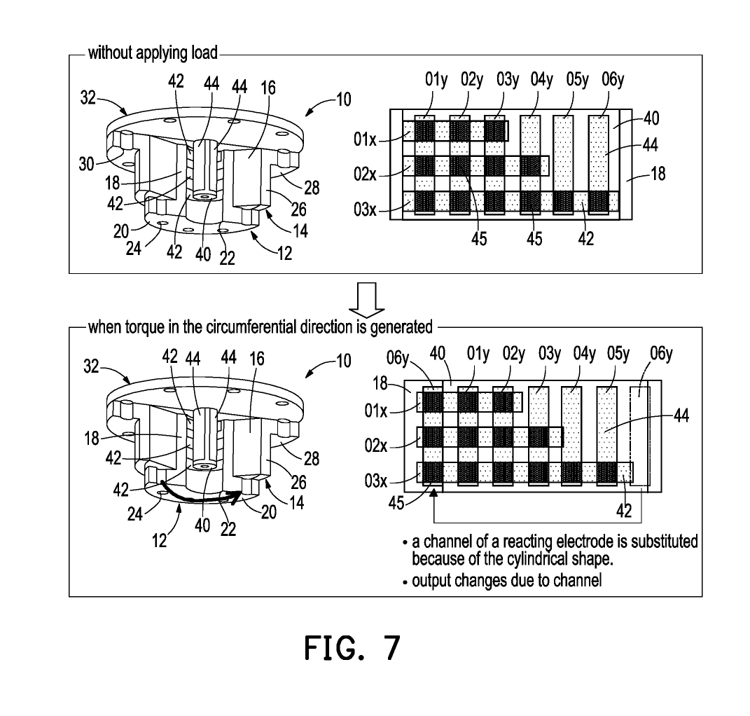

In addition, FIG. 7 shows that the inner shaft member 12 and the outer tube member 14 relatively displace in the circumferential direction. That is, if the inner shaft member 12 and the outer tube member 14 relatively displace (rotate) in the circumferential direction, with respect to an initial state shown as “without applying load” in FIG. 7, the first electrodes 42 and the second electrodes 44 relatively displace in the axial direction as in a state shown as “when a torque in the circumferential direction occurs” in FIG. 7. In this way, the 01x of the first electrode 42 and the 03y of the second electrode 44 is not in cross-facing state, and the cross-facing area of the 02x of the first electrode 42 and the 04y of the second electrode 44 becomes small, and the detection value of the electrostatic capacitance reduces in any cross-facing part (the sensor element 45). On the other hand, the 06y of the second electrode 44 faces and crosses the 01x, 02x of the first electrodes 42 because of the displacement in the circumferential direction, and the electrostatic capacitances are detected in the cross-facing part of the 01x, 02x of the first electrodes 42 and the 06y of the second electrode 44. Based on the change of the electrostatic capacitance detected by the first sensor 46, a presence or absence of the relative displacement in the circumferential direction of the inner shaft member 12 and the outer tube member 14, the direction of the relative displacement, and the relative displacement amount, etc., may be detected.

In addition, in the first sensor 46 of the embodiment, a relative displacement of the inner shaft member 12 and the outer tube member 14 in a direction perpendicular to the axial direction can also be detected by the sensor elements 45 that are arranged dispersively across the entire circumference. That is, if the inner shaft member 12 and the outer tube member 14 relatively displace in the direction perpendicular to the axial direction, the first electrode 42 provided on the inner shaft member 12 and the second electrode 44 provided on the insertion shaft member 40 of the outer tube member 14 get close to one another in a portion in the circumferential direction, and are separated from one another in another portion in the circumferential direction. In this way, in the first sensor 46, as the detection values of the electrostatic capacitances become large for the sensor elements 45 provided in the portion where the first electrode 42 and the second electrode 44 get close, and the detection values of the electrostatic capacitances become small for the sensor elements 45 provided in the portion where the first electrode 42 and the second electrode 44 are separated. The relative displacement toward the direction perpendicular to the axial between the inner shaft member 12 and the outer tube member 14 and the direction of the relative displacement can be detected based on the detection results.

The resilient coupling device 10 having such a configuration is attached, for example, between the end effector portion 58 and the arm portion 60 of the robot arm which are object members to be coupled. That is, as shown in FIG. 3, the inner shaft member 12 is mounted to the end effector portion 58 by inner mounting bolts 62 that are screwed into the inner mounting hole 24, and the outer tube member 14 is mounted to the arm portion 60 by outer mounting bolts 36 that are inserted into the outer mounting holes 30 and the nuts 38 that are screwed to the outer mounting bolts 36. In this way, vibration-proof coupling is provided through the resilient coupling device 10 between the end effector portion 58 and the arm portion 60, and the relative displacement of the end effector portion 58 and the arm portion 60 is detected by the first sensor 46 of the resilient coupling device 10.

According the resilient coupling device 10 having the configuration of the embodiment, the relative displacement of the first electrodes 42 and the second electrodes 44 is detected based on the change of the electrostatic capacitance that is detected by the first sensor 46, so that the amount and the direction of the relative displacement of the inner shaft member 12 and the outer tube member 14 can be detected by the first sensor 46.

Furthermore, the insertion shaft member 40 of the outer tube member 14 is inserted into the inner hole 22 of the inner tubular portion 18 of the inner shaft member 12, the first electrodes 42 are fixed to the inner peripheral surface of the inner tubular portion 18, and the second electrodes 44 is fixed to the outer peripheral surface of the insertion shaft member 40. Therefore, in comparison with that the sensor is arranged outward in the axial direction, the resilient coupling device 10 can be miniaturized in the axial direction.

In addition, by an energy attenuation action or a vibration insulation action caused by an internal friction of the main rubber resilient body 16, an input to the first sensor 46 is reduced, so that a detection of an input by the first sensor 46 can be prevented from being oversensitive. Therefore, a relatively large input requiring detection can be detected effectively by the first sensor 46, and a relatively small input (a vibration inputted from surroundings) not requiring detection can be prevented from being detected by the first sensor 46. Therefore, it is easy to selectively detect a force that should be detected, and a wrong operation caused by an unnecessary detection of force can be prevented. Also, the filtering by software and the like becomes unnecessary and the simplification and so on of a detection program can be realized.

In addition, the sensor elements 45 of the first sensor 46 are respectively configured the plurality of cross-facing parts of the first electrodes 42 and the second electrodes 44, and therefore an improvement of the detection precision or detections of the displacements of the inner shaft member 12 and the outer tube member 14 in plural directions can be realized. In particular, the lengths in the circumferential direction of the 01x, 02x, 03x of the first electrodes 42 are mutually different, and numbers of the cross-facing parts of the 01x, 02x, 03x of the first electrodes 42 and the 01y-06y of the second electrodes 44 are mutually different, so that the relative displacement of the inner shaft member 12 and the outer tube member 14 can be detected in multiple directions.

Furthermore, the cross-facing parts of the first electrodes 42 and the second electrodes 44 that form the sensor elements 45 of the first sensor 46 are arranged in a matrix form, by which the improvement of the detection precision or the detections in the multiple directions of the displacement of the inner shaft member 12 and the outer tube member 14, etc., are effectively realized. In this way, for example, the detection of a displacement in a prying direction in which each center axis of the inner shaft member 12 and the outer tube member 14 relatively tilts can also be realized.

In addition, the inner tubular portion 18 of the inner shaft member 12 to which the first electrode 42 is fixed and the insertion shaft member 40 of the outer tube member 14 to which the second electrode 44 is fixed are spaced apart without being coupled by a rubber resilient body and the like, by which the first sensor 46 can be provided without affecting the spring property of the resilient coupling device 10. Therefore, by adjusting the spring property of the main rubber resilient body 16, a target of resilient coupling performance, anti-vibration performance or the like can be easily and accurately realized.

In addition, by comparing the detection value of the electrostatic capacitance of the first sensor 46 with a preset reference value of the electrostatic capacitance, an action subject to an abnormal external force or a performance change due to a deterioration of the main rubber resilient body 16, etc., can be detected.

In addition, the use of the detection results of the first sensor 46 is not particularly limited; for example, by comparing the detection results with a reference values (map) of the electrostatic capacitances that should be detected when the robot arm is normally operated, an abnormal operation of the robot arm or the deterioration of the main rubber resilient body 16 can be identified. That is, an abnormality detecting device 64 that includes a ROM (Read Only Memory) storing a change modes (map) of the electrostatic capacitances as reference is provided in the sensor controller 48, and the abnormality detecting device 64 compares the detection results of the electrostatic capacitances and the reference values (map) of the electrostatic capacitances that are stored in the abnormality detecting device 64. Furthermore, when the detection values of the electrostatic capacitances in the first sensor 46 exceed an error threshold and differ greatly from the reference values of the electrostatic capacitances stored in the ROM, the abnormality detecting device 64 can detect the abnormality, and transmits an abnormal signal to an external abnormality reporting means or a device controller of a robot through a transmission path of the abnormal signal by wire or by wireless way if necessary, to notify the outside by a sound or a screen display or forcibly stopping the robot arm.

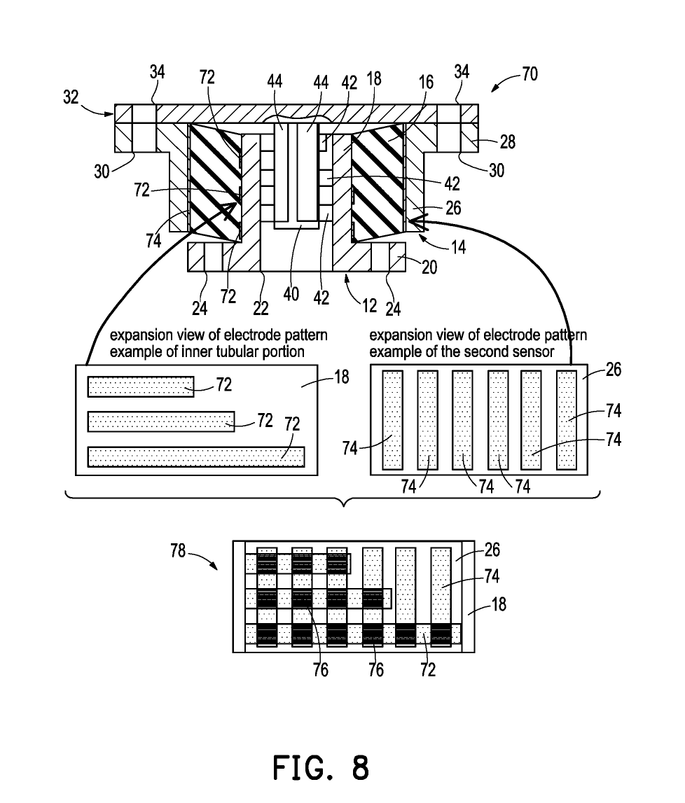

A resilient coupling device 70 according to the second embodiment of the present disclosure is shown in FIG. 8. The resilient coupling device 70 has a structure in which third electrodes 72 are fixed to the outer peripheral surface of the inner tubular portion 18 of the inner shaft member 12 in a state of electrical insulation, and fourth electrodes 74 are fixed to the inner peripheral surface of the outer tubular portion 26 of the outer tube member 14 in a state of electrical insulation. In the following description, the members and the portions that are substantially the same with the first embodiment are assigned with the same numerals in the drawings, and the corresponding description is omitted.

More specifically, the third electrodes 72 are provided on the outer peripheral surface of the inner tubular portion 18 to extend in the circumferential direction, and three third electrodes are mutually arranged in the axial direction with a predetermined distance like the first electrodes 42, and lengths of the three third electrodes 72, 72, 72 in the circumferential direction are mutually different. In addition, the third electrodes 72 are provided at locations where the first electrodes 42 provided on the inner peripheral surface of the inner tubular portion 18 are shifted in the axial direction, and a detection error caused by the arrangement of capacitors between the first electrodes 42 and the third electrodes 72 is difficult to occur.

The fourth electrodes 74 are provided on the outer peripheral surface of the outer tubular portion 26 to extend in the axial direction. Like the second electrodes 44, six fourth electrodes 74 are mutually arranged in the circumferential direction with a predetermined distance and these six fourth electrodes 74, 74 . . . 74 have substantially the same shape and size.

Furthermore, the inner tubular portion 18 of the inner shaft member 12 is inserted into the outer tubular portion 26 of the outer tube member 14, and thus the third electrodes 72 and the fourth electrodes 74 cross one another at a plurality of locations and face one another in the radial direction. In addition, the main rubber resilient body 16 of electrical insulation is arranged in the radial direction between the inner tubular portion 18 of the inner shaft member 12 and the outer tubular portion 26 of the outer tube member 14, and thus the main rubber resilient body 16 is interposed in the cross-facing parts of the third electrodes 72 and the fourth electrodes 74. In these ways, the capacitors that have the main rubber resilient body 16 as the dielectric layer are respectively formed at the cross-facing parts of the third electrodes 72 and the fourth electrodes 74, and a second sensor 78 of electrostatic capacitance type having the capacitors as sensor elements 76 is formed.

Also in the second sensor 78, similar to the first sensor 46, the relative displacement of the inner shaft member 12 and the outer tube member 14 can be detected based on the detection values of the electrostatic capacitances. In addition, the principle for detecting the relative displacement of the inner shaft member 12 and the outer tube member 14 by the second sensor 78 is the same as the first sensor 46, thus the description is omitted.

According to the resilient coupling device 70 including the second sensor 78, the relative displacement of the inner shaft member 12 and the outer tube member 14 can also be detected by the detection results of the second sensor 78 in addition to the detection results of the first sensor 46, and therefore, the improvement of the detection precision and the reliability can be realized. Moreover, by comparing the detection results of the first sensor 46 and the second sensor 78, malfunction or the like of any one of the first sensor 46 and the second sensor 78 can be identified quickly.

In addition, in the second sensor 78 of the embodiment, the main rubber resilient body 16 as a dielectric layer having a dielectric constant larger than the air is interposed in the cross-facing part of between the third electrode 72 and the fourth electrode 74 in the sensor element 76, so that compared with a case that the air serves as the dielectric layer, the electrostatic capacitance of each sensor element 76 is larger, and the detection of force based on the change of the electrostatic capacitance may be realized in higher precision.

In addition, in the embodiment, although an electrostatic capacitance sensor is used as an example of the second sensor 78, the detection method of the second sensor 78 is not limited to the electrostatic capacitance type. For example, an electrical resistance sensor can also be used as the second sensor 78. That is, the main rubber resilient body 16 arranged between the third electrodes 72 and the fourth electrodes 74 in the radial direction is formed by a pressure sensitive rubber which is obtained by mixing a conductive filler into a rubber material, and the electrical resistance of the main rubber resilient body 16 is changed by a resilient deformation of the main rubber resilient body 16 that accompanies the relative displacement of the inner shaft member 12 and the outer tube member 14. Furthermore, an electrical resistance sensor, which is capable of detecting the relative displacement of the inner shaft member 12 and the outer tube member 14 by applying a detection voltage to the cross-facing parts of the third electrodes 72 and the fourth electrodes 74 to detect the resilient deformation of the main rubber resilient body 16 based on change of the electrical resistance, may also be used as the second sensor 78. In this way, by setting the first sensor 46 and the second sensor 78 to sensors of mutually different detection methods, further improvement or the like of the detection precision and the reliability can be realized.

Although the embodiment of the present disclosure is described above in detail, the present disclosure is not limited to the specific description. For example, in the embodiment, the insertion shaft member 40 is provided in the mounting member 32 that is separated from the outer tube member 14, and by integrally coupling the outer tube member 14 and the mounting member 32, the insertion shaft member 40 is provided in the outer tube member 14. However, the insertion shaft member 40 and the outer tube member 14 may also be formed as a single member.

Furthermore, the insertion shaft member 40 of the outer tube member 14 can be inserted from any side in the axial direction to the inner hole 22 of the inner tubular portion 18 of the inner shaft member 12. Furthermore, the tubular portion provided in the inner shaft member is not necessarily limited to the structure such as the inner tubular portion 18 which includes the inner hole 22 to pass through and can also be a bottomed tubular shape with a concave inner hole which only one side is opened.

In addition, in the embodiment, an exemplary structure is shown that a space is formed in the radial direction between the inner tubular portion 18 of the inner shaft member 12 and the insertion shaft member 40 of the outer tube member 14, and the first electrodes 42 and the second electrodes 44 are separated by a space to face one another. However, for example, the following structure may also be used in which the inner tubular portion 18 and the insertion shaft member 40 are resiliently coupled by the rubber resilient body in the radial direction, and the rubber resilient body is interposed between the cross-facing parts of the first electrodes 42 and the second electrodes 44. According to this, in the capacitors (the sensor elements 45) which are formed in the cross-facing parts of the first electrodes 42 and the second electrodes 44, the electrostatic capacitance becomes larger because the rubber resilient body serves as the dielectric layer, so that such as the improvement of the detection precision of the relative displacement of the inner shaft member 12 and the outer tube member 14 by the first sensor 46 can be obtained. In addition, a spring constant of the rubber resilient body which is provided on the cross-opposing parts between the first electrodes 42 and the second electrodes 44 in the radial direction is smaller than a spring constant of the main rubber resilient body 16, and the rubber resilient body may be a rubber that is easily deformed and softer in comparison with the main rubber resilient body 16.

Furthermore, in the structure where the rubber resilient body is interposed in the radial direction between the first electrodes 42 and the second electrodes 44 that face one another, by using the rubber resilient body as a pressure sensitive rubber of which the electrical resistance is changed with the resilient deformation, the sensor elements 45 of the first sensor 46 can serve as electrical resistance sensor elements, and the relative displacement of the inner shaft member 12 and the outer tube member 14 can be detected based on the detected change of the electrical resistance.

In addition, in the embodiment, the first electrodes 42 and the second electrodes 44 are both thin strip shape and are arranged to extend in the relatively inclined directions and face to cross one another, but the specific shape of the first electrodes 42 and the second electrodes 44 is not limited to this. More specifically, for example, a structure that the first electrodes are provided to cover almost the entire inner peripheral surface of the inner tubular portion 18 of the inner shaft member 12, or a structure that the second electrodes are provided to cover almost the entire outer peripheral surface of the insertion shaft member 40 of the outer tube member 14 may also be used. Furthermore, for example, a structure may also be used that the first electrodes and the second electrodes formed by thin film of substantially square shape are arranged to mutually face one another in the radial direction, and multiple sets of the facing first electrodes and the second electrodes are provided in a matrix form so as to be arranged in the axial direction and the circumferential direction.

Furthermore, when the first electrodes 42 and the second electrodes 44 are the strip-shaped thin film like the embodiment above, the first electrodes 42 and the second electrodes 44 do not necessarily strictly extend to any one of the axial direction and circumferential direction. As long as the first electrodes 42 and the second electrodes 44 face and cross to be relatively inclined, the first electrodes 42 and the second electrodes 44 may also extend to a direction inclined with respect to the axial direction or the circumferential direction.

In addition, a specific shape, arrangement or number and the like of the third electrodes 72 and the fourth electrodes 74 may also be changed appropriately like the first electrodes 42 and the second electrodes 44.

In addition, a mounting structure of the inner shaft member 12 to the end effector portion 58 or a mounting structure of the outer tube member 14 to the arm portion 60 is not particularly limited and may be changed. Specifically, for example, the outer tube member 14 may also be mounted to the arm portion 60 by press-fitting the outer tubular portion 26 of the outer tube member 14 to a mounting tubular portion provided on the arm portion 60.

In addition, the resilient coupling device of the present disclosure is not necessarily limited to the application to a coupling portion of the end effector portion and the arm portion of the robot arm. Specifically, the resilient coupling device may also be applicable to a coupling portion of a power unit and a vehicle body of an automobile and so on, or to a supporting portion of a bridge, and the like. Furthermore, the present disclosure is applicable to not only an arm portion of an industrial robot, but also an arm portion of a nursing robot or a medical robot that is expected to contact people actively. On this occasion, when the arm portion contacts people, a contact which absorbs shocks based on resilience of the main rubber resilient body is realized, and safety may also be improved by detecting abnormality in the contact direction, contact pressure and the like.

Other Configurations

Embodiments of the present disclosure for solving such issues are described. In addition, constitute elements used in each embodiment described below can be used by any possible combination.

According to the first aspect of the present disclosure, in a resilient coupling device, which has a structure that an inner shaft member is inserted into an outer tube member and the inner shaft member and the outer tube member are resiliently coupled in a radial direction by a main rubber resilient body, the inner shaft member is provided with a tubular portion, the outer tube member is provided with an insertion shaft member extending in an axial direction, the insertion shaft member is inserted into an inner hole of the tubular portion in the inner shaft member, an outer peripheral surface of the insertion shaft member and an inner peripheral surface of the tubular portion in the inner shaft member are separated from and face one another in the radial direction, the inner peripheral surface of the tubular portion in the inner shaft member is provided with a first electrode, the outer peripheral surface of the insertion shaft member of the outer tube member is provided with a second electrode. A first sensor, which detects an electrical change that accompanies a relative displacement of the first electrode and the second electrode, comprises the first electrode and the second electrode.

According to the resilient coupling device having the aforementioned first aspect, the relative displacement of the first electrode and the second electrode is detected as a change of an electrostatic capacitance detected in the first sensor, so that the relative displacement of the inner shaft member and the outer tube member, i.e., magnitude and direction and the like of the force acting between the inner shaft member and the outer tube member can be detected by the first sensor.

Furthermore, the insertion shaft member of the outer tube member is inserted into the inner hole of the tubular portion of the inner shaft member, the first electrode is fixed to the inner peripheral surface of the tubular portion, and the second electrode is fixed to the outer peripheral surface of the insertion shaft member, so that the first sensor can be provided with a good space efficiency in the resilient coupling device having a small axial size.

In addition, by an energy attenuation action or a vibration insulation action of the main rubber resilient body, an input to the first sensor is reduced, thus the first sensor can be prevented from oversensitively detecting the input, and a relatively small force unnecessary for the detection of the vibration input from surroundings can be prevented from being detected, while a relatively large force necessary for the detection can be detected. Therefore, the force of the detection object can be easily and selectively detected, and a wrong operation caused by the detection of the unnecessary force, or complication of an arithmetic processing that is provided for preventing the detection of the unnecessary force by a software is avoided.

According to the second aspect the present disclosure, in the resilient coupling device according to the first aspect, the first sensor is an electrostatic capacitance sensor that detects a change of an electrostatic capacitance that accompanies the relative displacement of the first electrode and the second electrode.

According to the above second aspect, based on the change of the electrostatic capacitance caused by a change in an area of the facing part or in a facing distance of the first electrode and the second electrode, the relative displacement of the inner shaft member and the outer tube member can be precisely detected.

According to the third aspect of the present disclosure, in the resilient coupling device according to the first or second aspect, a plurality of the first electrodes are provided on the inner peripheral surface of the tubular portion in the inner shaft member, and a plurality of the second electrodes are provided on the outer peripheral surface of the insertion shaft member in the outer tube member.

According to the above third aspect, since sensor elements of the first sensor are respectively formed in the opposing parts of the plurality of the first electrodes and the plurality of the second electrodes, improvement of detection precision or detection of the displacement of the inner shaft member and the outer tube member in multiple directions can be implemented.

According to fourth aspect of the present disclosure, in the resilient coupling device according to the third aspect, the facing parts of the plurality of the first electrodes and the plurality of the second electrodes is arranged in a matrix form.

According to the above fourth aspect, by arranging the facing parts of the first electrodes and the second electrodes which form the sensor elements of the first sensor in the matrix shape, the improvement of the detection precision, or the detection of the displacement of the inner shaft member and the outer tube member in multiple directions can be efficiently implemented.

According to the fifth aspect of the present disclosure, in the resilient coupling device according to any one of the first to the fourth aspects, a space is formed in the radial direction between the tubular portion of the inner shaft member provided with the first electrode and the insertion shaft member of the outer tube member provided with the second electrode.

According to the above fifth aspect, by spacing apart the tubular portion of the inner shaft member to which the first electrodes is fixed and the insertion shaft member of the outer tube member to which the second electrodes are fixed without being coupled by the rubber resilient body, etc., the first sensor can be provided without affecting the spring property of the resilient coupling device. Therefore, by adjusting the spring property of the main rubber resilient body, targets of resilient coupling performance and anti-vibration performance can be easily realized.

According to the sixth aspect of the present disclosure, in the resilient coupling device according to any one of the first to the fifth aspects, a sensor controller that continually detects and stores the electrical change in the first sensor is provided, and an abnormality detecting device that detects an abnormality by comparing an amount of the electrical change detected by the first sensor with a reference value is provided.

According to the above sixth aspect, by comparing a detection value (such as an electrostatic capacitance value) of the electrical change of the first sensor with a preset reference value, an action subjection to an abnormal external force or a performance change due to a deterioration of the main rubber resilient body, etc., can be detected.

According to the seventh aspect of the present disclosure, in the resilient coupling device according to any one of the first to the sixth aspects, the outer peripheral surface of the inner shaft member is provided with a third electrode, the inner peripheral surface of the outer tube member is provided with a fourth electrode, and a second sensor that detects a relative displacement of the third electrode and the fourth electrode is configured to include the third electrode and the fourth electrode.

According to the above seventh aspect, by referring to the detection result of the second sensor in addition to the detection result of the first sensor, the relative displacement of, for example, the inner shaft member and the outer tube member can be more precisely detected, and failure of any sensor can be identified, or damage can be avoided by using another sensor when a failure occurs in one sensor, and the reliability is improved.

According to eighth aspect of the present disclosure, in the resilient coupling device according to the seventh aspect, the main rubber resilient body with electrical insulation is arranged in the radial direction between the third electrode and the fourth electrode, and the second sensor is an electrostatic capacitance sensor that detects the relative displacement of the third electrode and the fourth electrode by a change of the electrostatic capacitance.

According to the above eighth aspect, by using the main rubber resilient body as an insulator layer, the value of the electrostatic capacitance in the electrostatic capacitance second sensor can be increased, and a higher detection precision can be realized.

According to ninth aspect of the present disclosure, in the resilient coupling device according to the seventh aspect, the main rubber resilient body is arranged in the radial direction between the third electrode and the fourth electrode, the main rubber resilient body is a pressure sensitive rubber of which an electrical resistance changes with deformation, and the second sensor is an electrical resistance sensor that detects the relative displacement of the third electrode and the fourth electrode by a change of the electrical resistance of the main rubber resilient body.

According to the above configuration, by detecting the change of the electrical resistance that accompanies a resilient deformation of the main rubber resilient being as the pressure sensitive rubber, the relative displacement of the inner shaft member and the outer tube member can be detected. In particular, when the electrostatic capacitance sensor is used as the first sensor, by providing the second sensor with a detection scheme different from the first sensor, a high precisive detection may be realized by combining the first sensor and the second sensor.

According to the present disclosure, the insertion shaft member of the outer tube member is inserted into the inner hole of the tubular portion in the inner shaft member, the first electrode is fixed to the inner peripheral surface of the tubular portion, and the second electrode is fixed to the outer peripheral surface of the insertion shaft member, thus the relative displacement of the inner shaft member and the outer tube member can be detected by the first sensor, and the resilient coupling device can be miniaturized in the axial direction. In addition, an input to the first sensor is reduced by the anti-vibration action of the main rubber resilient body, thus the first sensor can be prevented from oversensitively detecting the input, and a relatively small force unnecessary for the detection of the vibration input from surroundings can be prevented from being detected, while a relatively large force necessary for the detection is detected.

What is claimed is:

1. A resilient coupling device, comprising:
an outer tube member, having an insertion shaft member extending in an axial direction;
an inner shaft member, inserted into the outer tube member and provided with a tubular portion, and the insertion shaft member being inserted into an inner hole of the tubular portion in the inner shaft member, an outer peripheral surface of the insertion shaft member and an inner peripheral surface of the tubular portion in the inner shaft member being separated from and facing one another in the radial direction;
a main rubber resilient body, resiliently coupling the inner shaft member and the outer tube member are resiliently coupled in a radial direction;
a first electrode, provided on the inner peripheral surface of the tubular portion in the inner shaft member;
a second electrode, provided on the outer peripheral surface of the insertion shaft member of the outer tube member; and
a first sensor, detecting an electrical change that accompanies a relative displacement of the first electrode and the second electrode and being configured to comprise the first electrode and the second electrode.

2. The resilient coupling device according to claim 1, wherein the first sensor is an electrostatic capacitance sensor which detects a change of an electrostatic capacitance that accompanies the relative displacement of the first electrode and the second electrode.

3. The resilient coupling device according to claim 1, wherein a plurality of the first electrodes are provided on the inner peripheral surface of the tubular portion in the inner shaft member, and a plurality of the second electrodes are provided on the outer peripheral surface of the insertion shaft member of the outer tube member.

4. The resilient coupling device according to claim 3, wherein cross-facing parts of the plurality of the first electrodes and the plurality of the second electrodes are arranged in a matrix form.

5. The resilient coupling device according to claim 1, wherein a space is formed in the radial direction between the tubular portion of the inner shaft member provided with the first electrode and the insertion shaft member of the outer tube member provided with the second electrode.

6. The resilient coupling device according to claim 3, wherein a space is formed in the radial direction between the tubular portion of the inner shaft member provided with the first electrode and the insertion shaft member of the outer tube member provided with the second electrode.

7. The resilient coupling device according to claim 1, further comprising:
a sensor controller, continually detects and stores the electrical change in the first sensor; and
an abnormality detecting device, detecting an abnormality by comparing an amount of the electrical change detected by the first sensor with a reference value.

8. The resilient coupling device according to claim 3, further comprising:
a sensor controller, continually detects and stores the electrical change in the first sensor, and
an abnormality detecting device, detecting an abnormality by comparing an amount of the electrical change detected by the first sensor with a reference value.

9. The resilient coupling device according to claim 1, further comprising:
a third electrode, provided on the outer peripheral surface of the inner shaft member;
a fourth electrode, provided on the inner peripheral surface of the outer tube member; and
a second sensor, detecting a relative displacement of the third electrode and the fourth electrode and being configured to comprise the third electrode and the fourth electrode.

10. The resilient coupling device according to claim 9, wherein the main rubber resilient body with electrical insulation is arranged between the third electrode and the fourth electrode in the radial direction, and the second sensor is an electrostatic capacitance sensor which detects the relative displacement of the third electrode and the fourth electrode by a change of an electrostatic capacitance.

11. The resilient coupling device according to claim 9, wherein the main rubber resilient body is arranged between the third electrode and the fourth electrode in the radial direction, the main rubber resilient body is a pressure sensitive rubber of which an electrical resistance changes with deformation, and
the second sensor is an electrical resistance sensor that detects the relative displacement of the third electrode and the fourth electrode by a change of the electrical resistance of the main rubber resilient body.
